(19) United States
(12) Patent Application Publication
(10) Pub. No.: US 2008/0235156 A1
(43) Pub. Date: Sep. 25, 2008

(54) Color Coded Price Indicators

(76) Inventor: Robert Amodeo, Indianola, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/688,180

(22) Filed: Mar. 19, 2007

(51) Int. Cl. G06F 17/00

(52) U.S. Cl. 705/400

(57) ABSTRACT

Create tiered price increments for goods and/or services, including information services, and communicate the tiered prices to potential customers through the use of color.

### TECHNICAL FIELD

The technical field of the invention relates generally to advertisements and more specifically to the use of color to communicate cost and other information in relation to obtaining a product or service, including an information service.

### BACKGROUND

Portable communication devices, such as, and without limitation, cell phones, Personal Digital Assistants (“PDA's”), Smart Phones, and the like typically have limited display capabilities. In addition, interactive voice and touch-tone systems must be designed with a minimum number of prompts to avoid excessive complexity in the user interface. Similarly, display space in print advertisements is constrained by cost and demand on viewer attention. These limitations make it difficult to communicate complex pricing plans to potential consumers, such as tiered pricing structures which may apply to one or more categories of products and/or services.

The art has provided at least one system which uses color or variable icon size to indicate call cost to the user of a portable communication device. See for example, U.S. patent application publication number 2004/0122684, wherein color and/or icon size serves to inform the user of a communication service regarding the anticipated and/or accrued cost of utilizing the communication service. Display of text such as “roaming” or of a roaming icon in the display area of a portable communication device is also well known in the art as a way to inform the user of a telecommunications service regarding the anticipated cost of utilizing the telecommunications service.

The art has also provided various computer and non-computer systems to aid in color selection and color scheme design, including tools to select a color palette based on colors found in a picture, tools to select contrasting colors (colors on the opposite side of either a RGB or RYB a color wheel), tools to select color triads (three colors equally spaced around a color wheel), tools to select four or more colors equally spaced around a color wheel, tools to select analogic colors (a base color plus two colors selected at thirty degrees on either side of the base color), tools to select a user specified number of colors within a certain angular separation (whether relative to a base color or relative to one another), and all of the foregoing tools which provide output in the form of color codes used by browsers, by computer monitors, by printers, and by other print and electronic display media.

In the context of print advertisements, color schemes are commonly selected for advertisements, thought to the knowledge of the applicant, such color schemes have not been used to communicate a tiered pricing plan with application to one or more categories of goods and/or services. To the knowledge of the applicant, this art does not teach, demonstrate, or suggest the use of color to communicate a tiered pricing plan with application to one or more categories of goods and/or services, including information services, nor has the art adopted the practice of using color to communicate a tiered pricing plan with application to one or more categories of goods and/or services, including information services.

### BRIEF SUMMARY OF THE INVENTION

The present invention utilizes color to communicate a tiered pricing plan with application to one or more categories of goods and/or services.

### BRIEF DESCRIPTION OF THE DRAWINGS

FIG. 1 is an exemplary drawing of an advertisement consistent with the principals of the invention and demonstrating one price tier and two categories of information services presented separately.

FIG. 2 is an exemplary drawing of an advertisement consistent with the principals of the invention and demonstrating two price tiers and two categories of information services presented together.

FIG. 3 is a process flow chart of exemplary steps consistent with the principals of the invention.

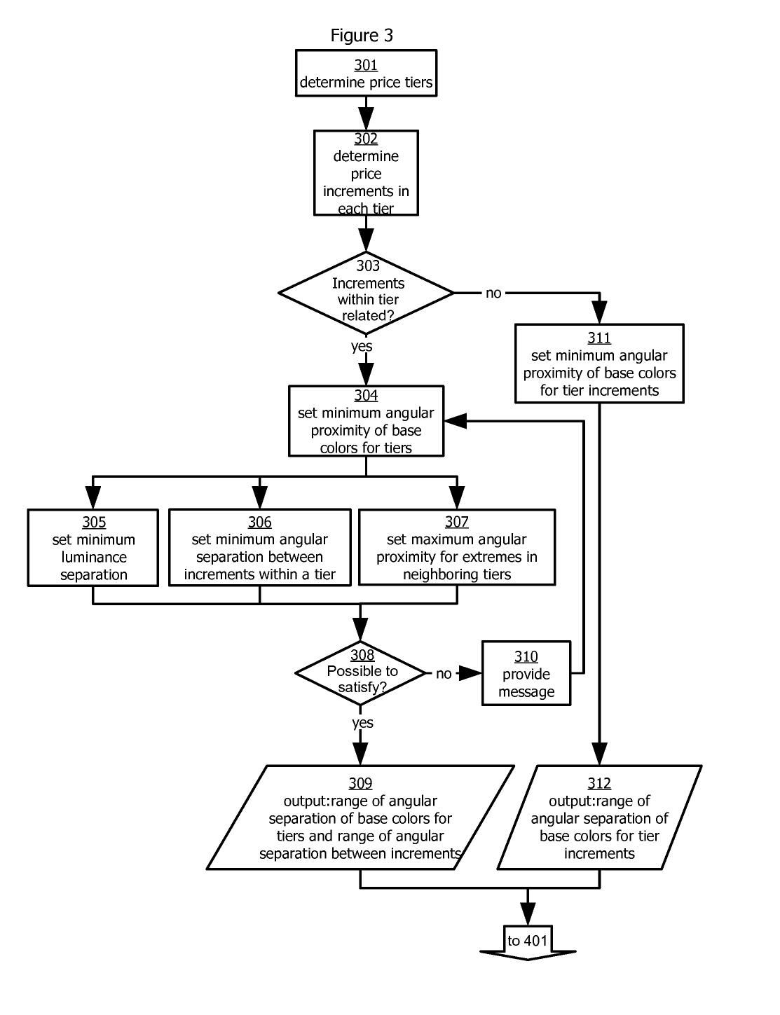

FIG. 4 is a process flow chart of exemplary steps consistent with the principals of the invention.

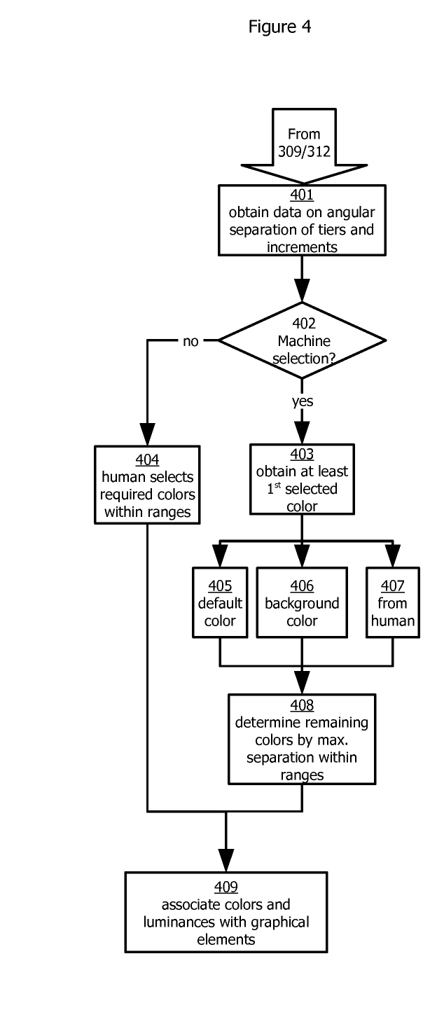

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some embodiments the functions may be performed by a processor, such as a computer or an electronic data processor, in accordance with code, such as computer program code, software, and/or integrated circuits that are coded to perform such functions.

Additionally, the processing that is depicted in the drawings and described below is generally depicted as hierarchal structure for readability and understandability. Various other methodologies, such as object oriented techniques, may be preferred for various physical embodiments of the invention in order to maximize the use of existing programming technique. One of ordinary skill in the art will appreciate that the techniques, methods and corresponding products and systems described herein may be embodied in many different forms.

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in the remote purchase of and access to goods, services and information of any type, including information services.

When a consumer uses a mobile phone or other telecommunications device to purchase a song, ringtone, or wallpaper (or similar), the consumer is obtaining an “information service.” Title 47 U.S.C. section 153(10) defines an “information service” as follows: “The term ‘information service’ means the offering of a capability for generating, acquiring, storing, transforming, processing, retrieving, utilizing, or making available information via telecommunications, and includes electronic publishing, but does not include any use of any such capability for the management, control, or operation of a telecommunications system or the management of a telecommunications service.” It shall be understood in this application that voice over IP (“VoIP”) telephony (wireless and wireline) shall also be included in the category of telecommunications service.

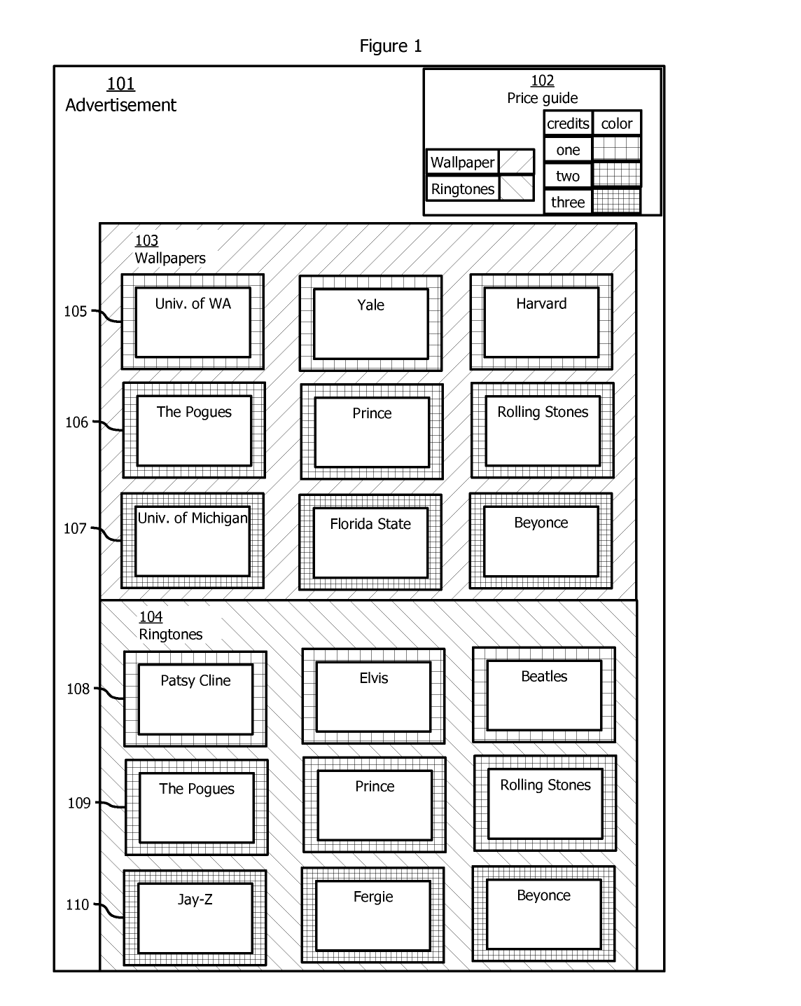

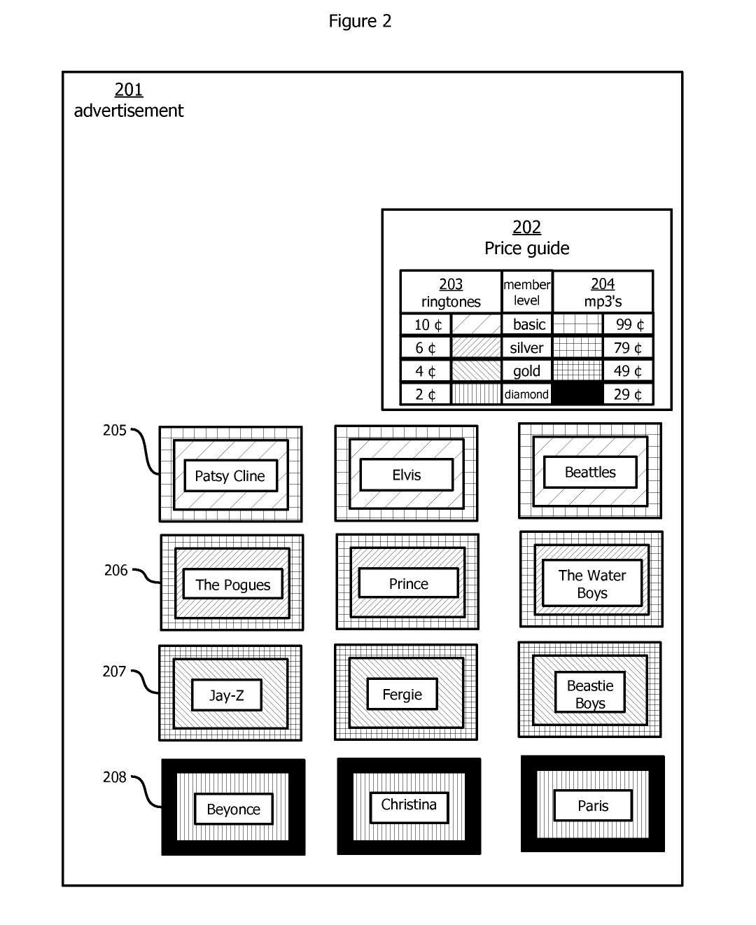

A party utilizing the method desires to market one or more categories of goods and/or services. The example demonstrated in FIGS. 1 and 2 are in relation to information services such as ringtones 103, wallpaper 102, and mp3s' 203. It should be understood that information services are presented as an example without limiting the claimed invention. The party wishes to communicate that one or more categories of information services are sold according to one or more price tiers, each price tier composed of one or more price increments. As depicted in FIG. 1, a first advertisement 101 demonstrates two categories of information services which are presented in two groups, wallpapers 102 and ringtones 103. In the advertisement 101, a different color is associated with each of these categories, while yet different colors are associated with each increment in the one price tier 102. The colors associated with the categories are used as background for two relatively large areas 103 and 104, while the colors associated with the increments are then associated with smaller graphical elements (in this case, rectangles 105 through 110. It would be obvious to one skilled in the art that the graphical elements are provided as simple examples and should not be understood to limit the claims or the disclosed invention. The graphical examples might consist, for example, of pictures, while the colors associated with the price increments may be applied to a border of variable size and shape surrounding such pictures.

As depicted in FIG. 2, a second advertisement 201 demonstrates two example categories of information services, ringtones 202 and mp3's 203, each associated with a price tier consisting of four increments, each of which increment is associated with a different color. Again, the choice of product or service, the number of tiers, and the number of increments within each tier should not be understood to limit the claimed invention. In this example, graphical elements 205 through 208 depict artists as text (as noted above, these could be replaced by a picture or other graphical element), while two colored borders surround each graphical element, each color in each boarder representing a price increment associated with a category of information service.

It is noted that the expression “different colors” and similar in this disclosure refers to different colors, including where the difference is based on luminance as well as on dominant electromagnetic frequency. It is known in the art that perceived luminance is determined in part by the average or background luminance, with smaller differences in absolute luminance being more noticeable if the average or background luminance is low. To the extent that luminance may be utilized in the disclosed invention, a minimum luminance separation may be provided to the invention 305, which luminance separation may be an absolute figure or may be a relative figure determined in part by the average or background luminance.

In one embodiment, the party utilizing the invention determines the number of price tiers 301 and the number of price increments in each tier 302. In one embodiment, a human then selects different colors for each increment in each tier and provides the colors for use with the different tiers and increments 409.

In another embodiment, after determining the number of price tiers 301 and the number of price increments in each tier 302, the next question is whether it is desirable for the increments within one or more of the tiers to be more closely related to one another by color, a “color related tier,” than to the other colors associated with other tiers 303. If they are not, then the invention may set and/or be provided with and/or determine the minimum angular separation of base colors for tier increments 311. The minimum angular proximity of base colors for tier increments may be determined by the maximum possible angular separation of base colors for tiers increments, based, for example and without limitation, on three-hundred and sixty degrees (or 2 pi in radians) divided by the total number of tier increments, plus a variable amount of off-set (ranging from zero to a number inversely proportional to the number of tier increments) on either side of this maximum to provide a range. The minimum angular proximity may also be set to a default level (determined, for example and without limitation, on past experience regarding ease of perception of difference between colors) or it may be provided by a user of the invention.

If the colors within at least one tier are meant to be related and comprise a color related tier, then the invention may then proceed to set and/or be provided with and/or determine the minimum angular proximity of the base colors for each of the color related tiers 304. As described in the preceding paragraph, this may be determined by the maximum possible angular separation of base colors for tiers determined by dividing three-hundred and sixty degrees by the number of color related tiers plus a variable amount of off-set (ranging from zero to a number inversely proportional to the number of tier increments) on either side of this maximum to provide a range. For example, if there are three tiers, the minimum angular separation of base colors chosen for each tier would be one-hundred and twenty degrees plus an amount of off-set, such as ten degrees. The minimum angular proximity may also be set to a default level (determined, for example and without limitation, on past experience regarding ease of perception of difference between colors) or it may be provided by a user of the invention.

The invented system then sets the minimum angular separation between increments within a color related tier 306, as well as the maximum angular proximity for the adjoining extremes in neighboring tiers 307, as well as the minimum luminance separation. These values may be provided by an embodiment of the invented system, based, for example, on values determined in the past to have be functionally distinguishable to a large percentage of the population with normal vision. These values may be provided by the user of the invention. The minimum angular proximity for adjoining extremes in neighboring tiers 307 should generally be greater than the minimum angular separation between increments within a tier 306, such that the increments within a color related tier will appear to be more related (appear to be closer in color to one another) than to the colors associated with other tiers.

The invention then determines if it is possible to satisfy the given constraints 308. It would be possible to satisfy the given constraints if the angles of separation for tier base colors and for increments within color related tiers, including the minimum angular proximity for increment extremes in neighboring tiers, multiplied by the number of tiers or increments ads up to less than three-hundred and sixty degrees. The greater the number of tiers and increments involved, the less angular separation is allowed between increments within a tier and between increment extremes in tiers with neighboring colors. If too many tiers and increments are involved, the color differences may not be perceivable and/or desirable, which may cause a party utilizing the system to evaluate use of luminance differences and/or to re-evaluate the number of tiers and increments and/or to consider other display options. If it is not possible to satisfy the constraints, then an embodiment of the invention may return a message or, equivalently, might modify the user interface of a computer system which embodies the invention to demonstrate, either graphically or through numbers, the degree to which the given constraints exceed the range of the available color palette. If it is possible to satisfy the constraints, then the invention provides output in the form of the range of angular separation which may exist between tier base colors and the range of angular separation between increments within color related tiers 309.

With the data on angular separation of tiers and increments 401, the invention may then proceed to selecting colors. In an embodiment, a question in this regard may be whether the color selection will be performed entirely by a computer system which embodies the invention or whether a human will select colors from within the provided ranges 402. A human may select colors within the provided ranges 404, or the system may proceed to obtain at least a first selected color 403. The first selected color may be a default color 405, it may be selected by reference to or by selected from a background color or another color already intended for use in the resulting advertisement or other display 406, or the first selected color may be chosen by a human 407. If the color is to be selected by reference to a background color, then the background color(s) may be included as a tier (with no increments) at the earlier stage of determining the number of price tiers 301. The reference background color is then selected as the first selected color 403, though it is not a color for a tier (or the increments within a tier) and it is thereby reserved from use by the tiers and increments. Not shown, other reserved colors, either absolute or relative, including a minimum proximity with respect to other colors may be included in those steps of the invention depicted in figure three which relate to the determination of the relative angular separation of the tier and increment colors. Not shown, preferred colors, such as those which may be easier to produce or which may be more consistently produced in a given display medium, may also be used to obtain and/or bias the selection of the at least first selected color 403.

With a determination of the at least first selected color 403, the invention may then determine the remaining colors 408, for example, by determining the maximum color separation which may be obtained given the ranges provided in the output 309 or 312. Another embodiment of the invention would bias the results to a best-fit with preferred colors and/or would provide for human interaction with the results to allow a human to fine tune the resulting color selections from within the provided ranges 309 and 312.

The resulting color selections are then provided for use in the advertisement or other display context 409. The output may be in the form of codes such as are used by different applications to produce color, such as in browsers, other electronic displays, printers, or in the context of mixing pigments.

The invention may be a stand-alone application implemented through conventional software programming techniques, it may be practiced by a human without aid of a computer system (particularly if a human is going to select colors as described above in paragraph [00016]), or it may be an applet implemented through conventional software programming techniques which provides colors to other computer software applications, such as a system which provides a large number of advertisements to one or more display media with minimal human involvement.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A method for communicating the cost of a good or service, including of an information service, comprising the following steps, not necessarily in the following order:
establishing at least one price tier with more than one increment;
assigning at least more than one color and/or luminance level to at least one of the at least one price tier and/or to the increments in at least one of the at least one price tier and;
associating at least one display element with at least one good or service, including an information service; and
displaying the at least one display element in association with the at least one assigned color and/or luminance.

2. The method according to claim 1, wherein the display media for the display is printed material.

3. The method according to claim 1, wherein the display media for the display is an electronic display.

4. The method according to claim 3, wherein the electronic display is associated with a mobile communications device.

5. The method according to claim 1, wherein colors are assigned to the tiers and/or increments are based at least in part on the maximum angular separation which may be obtained between a number of colors equal to the number of tiers and/or increments, when such a number of colors are graphed approximately equally spaced on a color wheel.

6. The method according to claim 1, wherein colors are assigned to the tiers and/or increments based at least in part on a minimum allowed angular proximity between different tier colors and/or increment colors, when graphed on a color wheel.

7. The method according to claim 1, wherein a base color is assigned to each of the at least one price tier and wherein colors for increments within at least one of the at least one price tier are selected from colors located at approximately equal distances from the tier base color and wherein colors assigned to increments within a tier are more closely located relative to one another when graphed on a color wheel than they are relative to the nearest color assigned to an increment in a neighboring tier.

8. The method according to claim 7 wherein the base colors assigned to price tiers are selected from colors which approximate a maximum angular separation between the colors, when graphed on a color wheel.

9. The method according to claim 1, wherein a base color is assigned to each of the at least one price tier and wherein increments within at least one of the at least one price tier are assigned the same color with different luminance levels.

10. The method according to claim 1, wherein the assignment of colors is based at least in part on determining a range of permissible angular separation between base colors for tiers and a range of angular separation between increments, if any, within each tier.

11. The method according to claim 10, wherein the determination of the ranges is based at least in part on a minimum angular separation between base colors for tiers.

12. The method according to claim 10, wherein the determination of the ranges is based at least in part on a minimum angular separation between increments within at least one of the at least one price tier.

13. The method according to claim 10, wherein the determination of the ranges is based at least in part on a maximum angular proximity between colors assigned to increments in adjoining tiers.

14. The method according to claim 1, wherein the assignment of colors to tiers and/or increments is based at least in part on other colors already selected for use in the display.

15. The method according to claim 14 wherein the assigned colors include at least one color already selected for use in the display.

16. The method according to claim 14 wherein the assigned colors exclude at least one color already selected for use in the display.

17. The method according to claim 1, wherein a human assigns at least one color and a machine assigns the remaining colors.

18. An advertisement, comprising:
a display medium capable of displaying color;
a graphical representation of at least one price tier comprising two or more increments applicable to at least one good and/or service, including an information service, which graphical representation associates at least two colors with the at least two or more increments and/or price tiers.

19. The advertisement according to claim 18, where the display medium for the advertisement is printed material.

20. The advertisement according to claim 18, where the display medium for the advertisement is electronic.

21. The advertisement according to claim 20, where the electronic display medium for the advertisement is the display for a portable communication device.

22. The advertisement according to claim 18, where the at least two colors are associated with the tiers and/or increments based at least in part on the maximum angular separation which may be obtained between a number of colors equal to the number of tiers and/or increments, when graphed on a color wheel.

23. The advertisement according to claim 18, where the at least two colors are associated with the tiers and/or increments are based at least in part on a minimum allowed angular proximity between different tier colors and/or increment colors, when graphed on a color wheel.

24. The advertisement according to claim 18, where a base color is associated with each of the at least one price tier and wherein colors for increments within at least one of the at least one price tier are selected from colors located at approximately equal distances from the tier base color and wherein colors assigned to increments within a tier are more closely located relative to one another when graphed on a color wheel than they are relative to the nearest color assigned to an increment in a neighboring tier.

25. The advertisement according to claim 24, where the base colors assigned to price tiers are selected from colors which approximate a maximum angular separation between the colors, when graphed on a color wheel.

26. The advertisement according to claim 18, where a base color is associated with each of the at least one price tier and where increments within at least one of the at least one price tier are associated with the same color with different luminance levels.

27. The advertisement according to claim 18, where the associated colors are based at least in part on a range of permissible angular separation between base colors for tiers and a range of angular separation between increments, if any, within each tier.

28. The advertisement according to claim 27, where the range is based at least in part on a minimum angular separation between base colors for tiers.

29. The advertisement according to claim 27, where the range is based at least in part on a minimum angular separation between increments within at least one of the at least one price tier.

30. The advertisement according to claim 27, where the range is based at least in part on a maximum angular proximity between colors associated with increments in adjoining tiers.

31. The advertisement according to claim 18, where the colors associated with tiers and/or increments are based at least in part on other colors already selected for use in the advertisement.

32. The advertisement according to claim 29, where the associated colors include at least one color already selected for use in the advertisement.

33. The advertisement according to claim 29, where the associated colors exclude at least one color already selected for use in the advertisement.

34. The advertisement according to claim 18, where at least one color is selected by a human and a machine selects the remaining colors.

35. A computer system to recommend and/or determine and/or facilitate the determination of colors to be associated with tiers and/or increments in an advertisement according to claim 18, comprising:
at least one data structure in which to store and/or identify a number of price tiers and/or increments;
a minimum angular proximity of base colors for increments, when such colors are graphed on a color wheel;
a minimum angular proximity of base colors for tiers, when such colors are graphed on a color wheel;
a maximum angular proximity between a color associated with an increment within a tier and the next closest color for an increment in a tier associated with an adjoining color, when such colors are graphed on a color wheel;
computer instructions that, when implemented, determine if it is possible to satisfy the conditions of minimum and maximum angular proximities with respect to the price tiers and/or increments;
computer instructions that, when implemented, select at least one color to associate with a price tier and/or increment;
at least one computer processor suitable to execute instructions;
at least one communication system which provides communication between the at least one data structure and the at least one computer processor;

36. The computer system according to claim 35, where a minimum angular proximity of base colors for tiers and/or colors for increments is based on maximum possible angular separation.

37. The computer system according to claim 35, where the computer instructions that, when implemented, select at least one color to associate with a price tier and/or increment, include instructions to select the at least one color based on at least one color already selected for use in the advertisement.

38. The computer system according to claim 37, where the instructions to select the at least one color based on at least one color already selected for use in the advertisement, exclude at least one color already selected for use in the advertisement.

39. The computer system according to claim 37, where the instructions to select the at least one color based on at least one color already selected for use in the advertisement, include at least one color already selected for use in the advertisement.
